(19) United States
(12) Patent Application Publication
(10) Pub. No.: US 2026/0034438 A1
(43) Pub. Date: Feb. 5, 2026

(54) MULTI-INPUT ADAPTOR FOR CONTROLLER

(71) Applicant: Hit Box, L.L.C., Las Vegas, NV (US)

(72) Inventors: Shawn Huffer, Henderson, NV (US); Dustin Huffer, Henderson, NV (US)

(21) Appl. No.: 19/032,992

(22) Filed: Jan. 21, 2025

Related U.S. Application Data
(60) Provisional application No. 63/678,162, filed on Aug. 1, 2024.

(51) Int. Cl. A63F 13/24

(52) U.S. Cl. CPC A63F 13/24

(57) ABSTRACT

A multi-input adaptor for a controller includes a housing having a base defining a base hole and an arm extending radially outward from the base, the arm defining a recess. The multi-input adaptor further includes a first input positioned within the base hole and a second input positioned within the recess of the arm. A first wiring system of the first input and a second wiring system of the second input each extend through the base hole of the base.

### CROSS-REFERENCE TO RELATED APPLICATION

This application claims priority to and the benefit of U.S. Provisional Application No. 63/678,162, filed Aug. 1, 2024, and entitled “DUAL-INPUT ADAPTOR FOR CONTROLLER,” the entire contents of which are hereby incorporated by reference in their entirety.

### FIELD OF THE INVENTION

The embodiments described herein relate to input adaptors for controllers, and more particularly, to multi-input adaptors that allow a user to increase the quantity of inputs on a controller.

### BACKGROUND

Arcade-style video game controllers are a staple in both casual and competitive gaming environments, offering a tactile and responsive interface for a variety of games. Traditional arcade-style controllers typically offer a joystick or buttons for movement and a plurality of buttons for in-game actions, such as jumping, dashing, kicking, punching, and other similar actions. In general, the number of buttons utilized on a particular controller correlates to the number of actions a user may take within the gaming environment. However, as the video game industry has advanced, the number of actions a user may take within various gaming environments has increased, such that the number of buttons afforded by traditional arcade-style controllers may be inadequate to perform each of the available actions within a gaming environment.

As a result, users of traditional arcade-style controllers often resort to modifying traditional controllers to add buttons or other input mechanisms in order to accommodate modern gaming environments. These modifications often lead to structural and/or wiring issues with the controller, which interfere with the ergonomic design of the controller and affect the gameplay experience of the user. Accordingly, a need exists for an input adaptor for a controller that allows a user to add additional buttons to a traditional controller.

### SUMMARY OF THE DISCLOSURE

In the embodiments of the present disclosure, a multi-input adaptor is disclosed. The multi-input adaptor for a controller includes a housing having a base defining a base hole and an arm extending radially outward from the base, the arm defining a recess. The multi-input adaptor further includes a first input positioned within the base hole and a second input positioned within the recess of the arm. A first wiring system of the first input and a second wiring system of the second input each extend through the base hole of the base.

In other embodiments of the present disclosure, a controller is disclosed. The controller includes, a casing, a plurality of input holes formed in the casing, a plurality of inputs positioned within the plurality of input holes, and at least one multi-input adaptor positioned in at least one of the plurality of input holes. The at least one multi-input adaptor includes a housing having a base defining a base hole and an arm extending radially outward from the base, the arm defining a recess. The multi-input adaptor further includes a first input positioned within the base hole and a second input positioned within the recess of the arm. A first wiring system of the first input and a second wiring system of the second input each extend through the base hole of the base and the at least one of the plurality of input holes.

In yet another embodiment of the present disclosure, a method is disclosed. The method of modifying a controller with a multi-input adaptor includes removing an input from an input hole formed in a casing of the controller, extending a first wiring system of a first input of the multi-input adaptor and a second wire of a second input of the multi-input adaptor through a base of a housing of the multi-input adaptor, inserting the multi-input adaptor into the input hole, such that the base of the housing of the multi-input adaptor extends into the input hole and an arm of the multi-input adaptor is positioned on a surface of the casing of the controller, and electrically coupling, via the input hole, the first wiring system of the first input and the second wiring system of the second input to a circuit board of the controller.

These aspects and other advantages and features are apparent from the following description taken in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a top-side perspective view of a controller including a multi-input adaptor, according to one or more embodiments shown and described herein;

FIG. 2A is a perspective view of a housing of the multi-input adaptor of FIG. 1, according to one or more embodiments shown and described herein;

FIG. 2B is a top view of the housing of FIG. 2A, according to one or more embodiments shown and described herein;

FIG. 3 is a perspective view of the multi-input adaptor of FIG. 1, according to one or more embodiments shown and described herein;

FIG. 4 is a front view of the multi-input adaptor of FIG. 1, according to one or more embodiments shown and described herein;

FIG. 5 is a rear view of the multi-input adaptor of FIG. 1, according to one or more embodiments shown and described herein;

FIG. 6A is a left-side view of the multi-input adaptor of FIG. 1, according to one or more embodiments shown and described herein;

FIG. 6B is a right-side view the multi-input adaptor of FIG. 1, according to one or more embodiments shown and described herein;

FIG. 7A is a bottom view of the multi-input adaptor of FIG. 1, according to one or more embodiments shown and described herein;

FIG. 7B is a bottom-side perspective view of the multi-input adaptor of FIG. 1, according to one or more embodiments shown and described herein; and

FIG. 8 is an illustrative flow diagram of a method of installing a multi-input adaptor on a controller, according to one or more embodiments shown and described herein.

### DETAILED DESCRIPTION

Embodiments disclosed herein relate to a multi-input adaptor for a controller. The multi-input adaptor for a controller includes a housing having a base defining a base hole and an arm extending radially outward from the base, the arm defining a recess. The multi-input adaptor further includes a first input positioned within the base hole and a second input positioned within the recess of the arm. A first wiring system of the first input and a second wiring system of the second input each extend through the base hole of the base. In the embodiments described herein, the multi-input adaptor may replace traditional controller inputs, thereby allowing a user to customize and/or modify the controller to increase the quantity of inputs available on the controller.

As should be appreciated, arcade-style video game controllers are commonly used in both casual and competitive gaming environments, offering a tactile and responsive interface for a variety of games. Traditional arcade-style controllers typically offer a joystick or buttons for movement and a plurality of buttons for in-game actions, such as jumping, dashing, kicking, punching, and other similar actions. However, standard arcade-style controllers present limitations when users wish to customize their controllers with additional buttons. For example, existing controllers do not support the addition of extra buttons through standard buttonholes. Instead, users are often forced to drill additional holes in the casing of the controller, or resort to other cumbersome and unreliable modification methods. These modifications often result in messy, non-flush wiring and may further compromise the integrity and aesthetics of the controller. Furthermore, such modifications often interfere with the ergonomic design of the controller, which may negatively affect the gameplay experience of the user.

The disclosed multi-input adaptor aims to resolve these issues by providing a button extender that allows users to add an additional button to a traditional arcade-style controller without modifying the physical structure of the controller. In particular, the multi-input adaptor includes a plurality of input mechanisms, such as a primary button and a secondary button, which may each be secured within a housing of the adaptor. In these embodiments, the primary button may be receivable within a standard buttonhole formed within a casing of a traditional controller, and the secondary button may be mounted on an arm of the housing that extends outwardly from the primary button. The wiring for the secondary button may extend through the housing of the adaptor and into the buttonhole in which the primary button is secured, such that the secondary button may be seamlessly integrated into the controller casing without compromising the structural integrity of the controller. By utilizing the multi-input adaptor described herein, users may be able to customize arcade-style controllers with additional buttons, providing for enhanced controller functionality while preserving the original design and ergonomics of the controller.

Embodiments of multi-input adaptors, controllers, and methods for installing multi-input adaptors will now be described in additional detail herein. The following will now describe these multi-input adaptors, controllers, and methods in more detail with reference to the drawings and where like numbers refer to like structures.

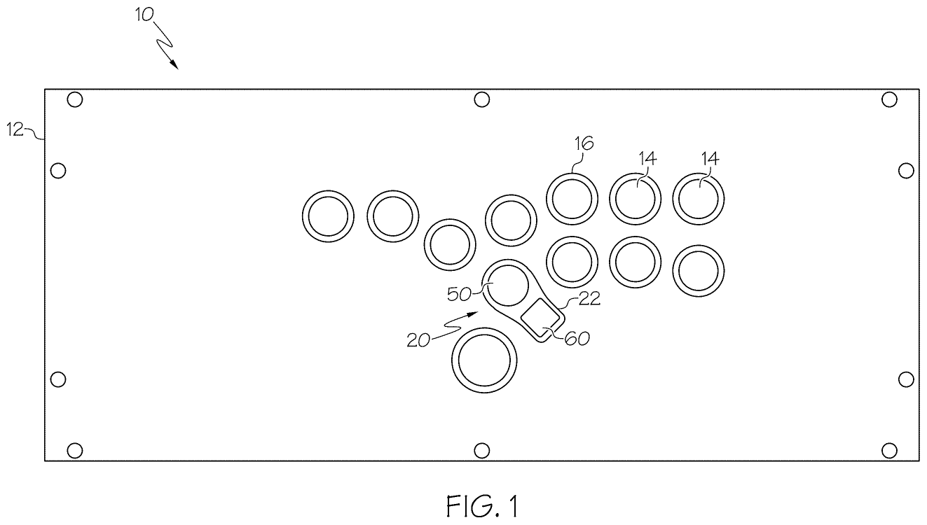

Referring now to FIG. 1, a controller 10 is depicted. In these embodiments, the controller 10 may be an arcade-style video game controller, or any other similar video game controller configured to allow a user to provide inputs into a gaming environment. As further depicted in FIG. 1, the controller 10 may include a casing 12, such as a shell or any other similar housing-like structure, and a plurality of inputs 14. In these embodiments, the plurality of inputs 14 may include buttons, D-pads, triggers, bumpers, analog sticks, touchpads, or any other similar input that allows a user to manipulate a gaming environment. The plurality of inputs 14 may be received within a plurality of input holes 16 formed within the casing 12 of the controller 10. For example, in these embodiments, each of the plurality of inputs 14 may be associated with one of the plurality of input holes 16, such that the number of the plurality of inputs 14 is equal to the number of the plurality of input holes 16.

As further depicted in FIG. 1, the controller 10 may further include a multi-input adaptor 20, which may allow a user to increase the quantity of the plurality of inputs 14 on the controller 10 without modifying the casing 12 of the controller 10 or increasing the quantity of the plurality of input holes 16. In these embodiments, the multi-input adaptor 20 may include multiple inputs confined within a housing 22 of the multi-input adaptor 20, with the wiring and/or circuitry of each of the multiple inputs extending through a common one of the plurality of input holes 16 formed in the casing 12 of the controller 10. For example, as illustrated in FIG. 1, the multi-input adaptor 20 may include at least a first input and a second input secured within the housing 22 of the multi-input adaptor 20. Accordingly, by utilizing the multi-input adaptor 20 depicted in FIG. 1, a user may be able to customize and/or modify the controller 10 such that the number of the plurality of inputs 14 exceeds the number of the plurality of input holes 16.

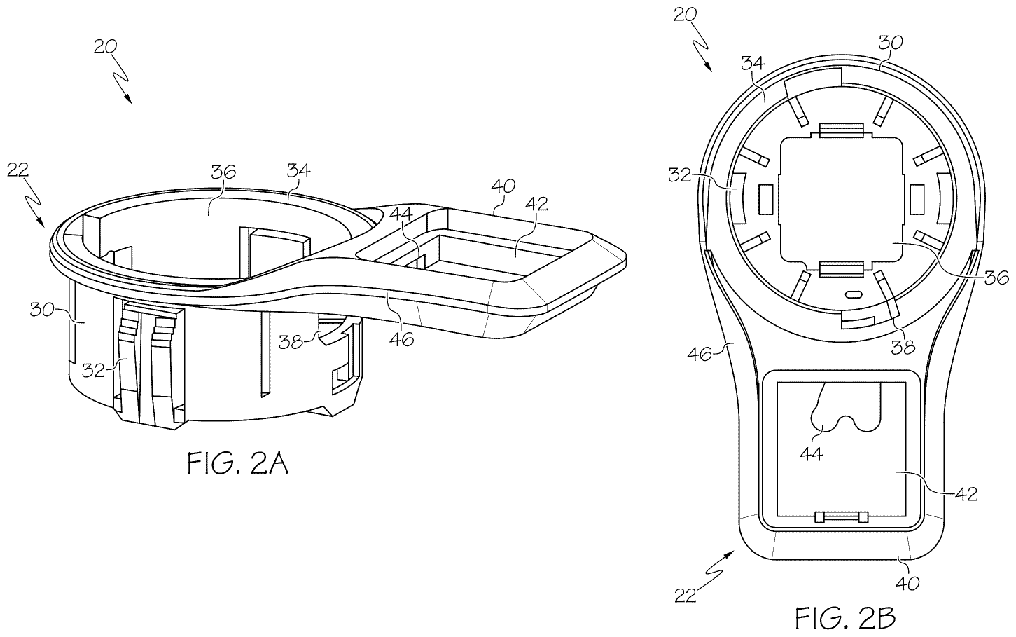

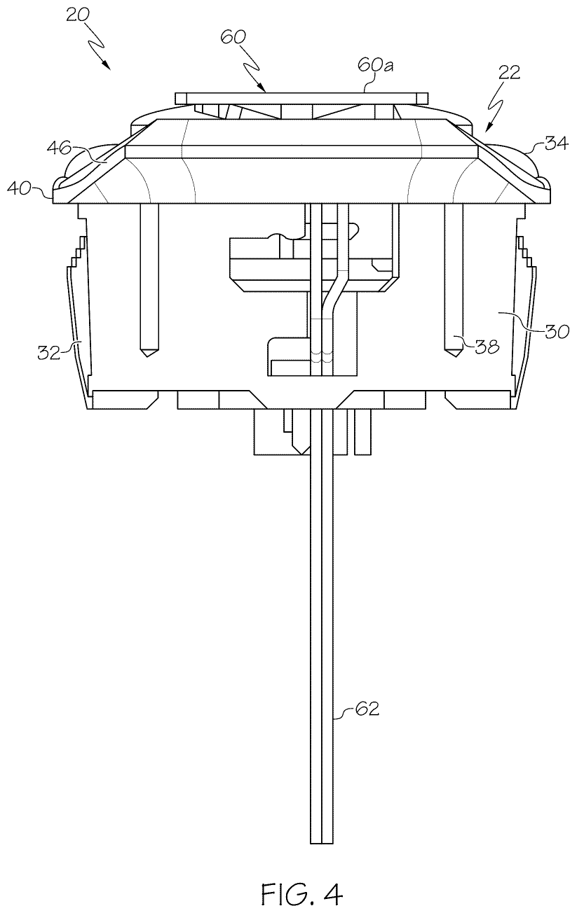

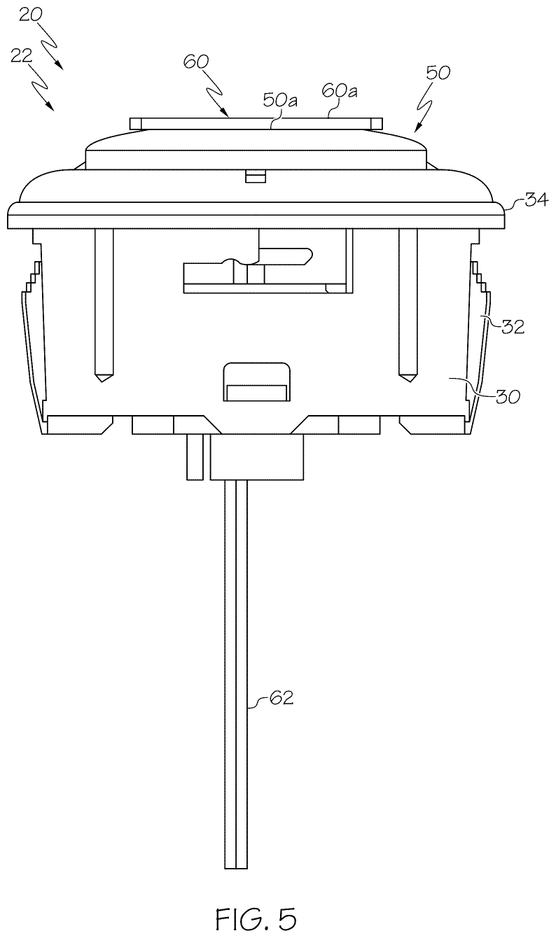

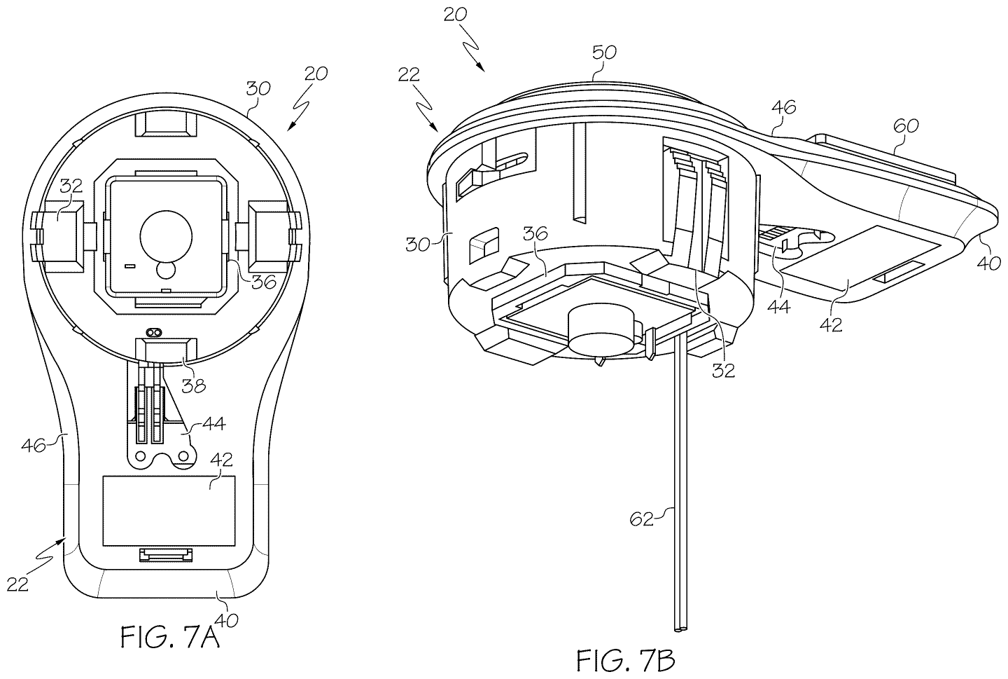

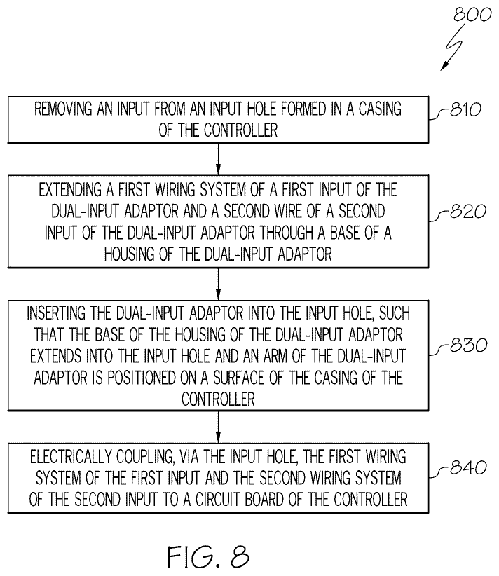

Although the controller 10 of FIG. 1 is depicted as including a single multi-input adaptor 20, it should be appreciated that the controller 10 may include any number of multi-input adaptors 20 without departing from the scope of the present disclosure. For example, in these embodiments, each of the plurality of input holes 16 may receive a multi-input adaptor 20, thereby allowing a user to double the number of the plurality of inputs 14 of the controller 10 without providing structural modifications to the casing 12 of the controller 10. The multi-input adaptor 20 will be described in additional detail herein with reference to FIGS. 2A-8B.

Referring now to FIGS. 2A and 2B, the housing 22 of the multi-input adaptor 20 is depicted in additional detail. In these embodiments, the housing 22 may include a base 30, which may be configured to receive a first input of the plurality of inputs 14. As depicted in FIGS. 2A and 2B, the base 30 of the housing 22 may be circular in shape, and may further include a plurality of projections 32 that extend radially outward from the base 30 of the housing 22. In these embodiments, the plurality of projections 32 may be elastically deformable (e.g., depressible in the +x-direction as depicted in the coordinate axes of FIGS. 2A and 2B) to allow the base 30 of the housing 22 to be positioned within any of the plurality of input holes 16 formed in the casing 12 of the controller 10 (e.g., as depicted in FIG. 1). For example, in these embodiments, a user may depress each of the plurality of projections 32 to position the base 30 of the housing 22 within one of the plurality of input holes 16. Once the base 30 of the housing 22 is positioned within its respective one of the plurality of input holes 16, the plurality of projections 32 may be released, such that each of the plurality of projections 32 is biased radially outward and secures the base 30 of the housing 22 within its respective one of the plurality of input holes 16.

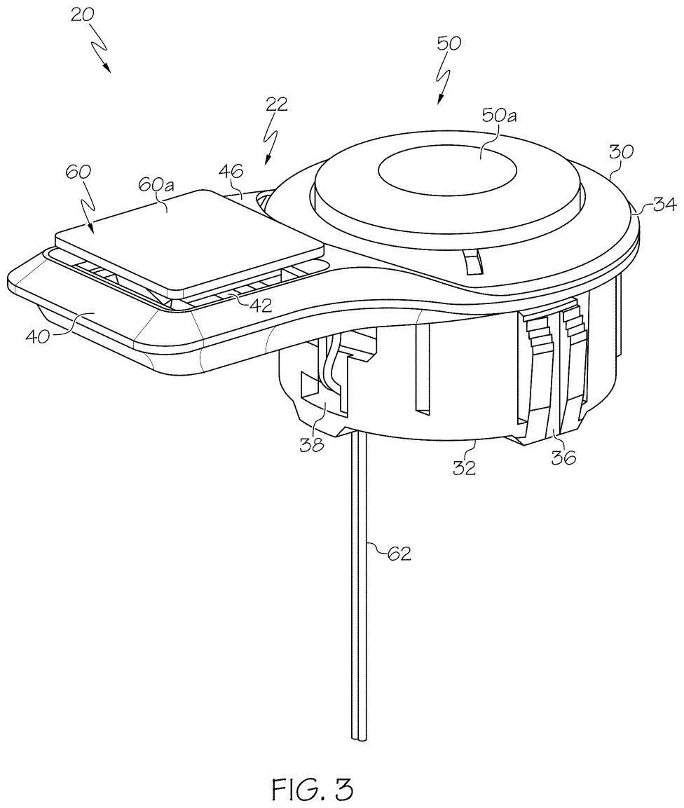

Referring still to FIGS. 2A and 2B, the base 30 may further include a rim 34 extending around (e.g., circumferentially) an outer perimeter of the base 30, with the rim 34 defining a base hole 36 that extends through the base 30. In these embodiments, an input, such as a first input, may be positioned within the base hole 36, such that the input contacts the rim 34 of the base 30 while a first wiring system of the input extends through the base hole 36 to be coupled to the internal circuitry of the controller 10. The interface of the inputs and the housing 22 of the multi-input adaptor 20 will be described in additional detail herein with reference to FIGS. 3-8B.

As further depicted in FIGS. 2A and 2B, the housing 22 may further include an arm 40, which may extend radially outward from the base 30 of the housing 22. In these embodiments, the arm 40 may include a recess 42, which may be configured to receive an input, such as a second input, as will be described in additional detail herein with reference to FIGS. 3-8B. The recess 42 may further include an arm aperture 44 extending at least partially through the arm 40, such that a second wiring system from the second input may extend through the arm aperture 44. In these embodiments, the base 30 may similarly include a base aperture 38 positioned adjacent the aperture 44 extending at least partially through the arm 40. Accordingly, the second wiring system of the second input may extend through the arm aperture 44, the base aperture 38, and into and through the base hole 36, such that the first wiring system and second wiring system for each of the first and second inputs of the multi-input adaptor 20 may be received within the same one of the plurality of input holes 16 formed in the controller 10.

Turning now to FIGS. 3-7B, the multi-input adaptor 20 is depicted with a plurality of inputs disposed within the housing 22. For example, in these embodiments, the base 30 may be configured to receive a first input 50, while the arm 40 of the housing 22 may be configured to receive a second input 60.

As described herein above, the first input 50 may be a button, or any other similar input, that may be configured to be received within the base 30 of the housing 22. For example, in these embodiments, the first input 50 may be a circular button, such that an edge of the button abuts the rim 34 of the base 30 of the housing 22 when the first input 50 is positioned within the housing 22. In these embodiments, the first wiring system of the first input 50 (not depicted) may extend through the base hole 36 formed in the base 30 such that the first input 50 may be coupled to the internal circuitry of the controller 10. Once the first input 50 is secured within the base 30 of the housing 22 and communicatively coupled to the controller 10, the first input 50 may be activated (e.g., depressed, etc.) to allow a user to manipulate a gaming environment.

Referring still to FIGS. 3-7B, the second input 60 may be a button, or any other similar input, that may be configured to be received within the recess 42 formed in the arm 40 of the housing 22. For example, in these embodiments, the second input 60 may be a square-shaped button, such that an edge of the second input 60 abuts the recess 42 formed in the arm 40 of the housing 22. In these embodiments, the second wiring system 62 of the second input 60 may extend through the arm aperture 44 formed in the recess 42 of the arm 40 and through the base aperture 38 formed in the base 30 of the housing 22. Accordingly, the second wiring system 62 of the second input 60 may extend through the base hole 36 formed in the base 30 of the housing 22, such that the second input 60 and first input 50 may be communicatively coupled to the controller 10 via a common (e.g., shared) input hole 16 formed in the controller 10.

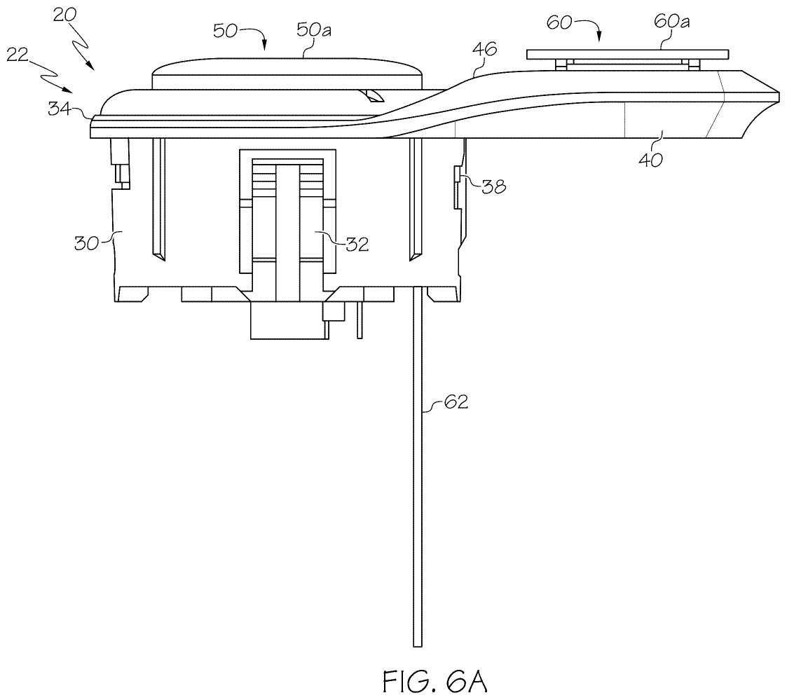

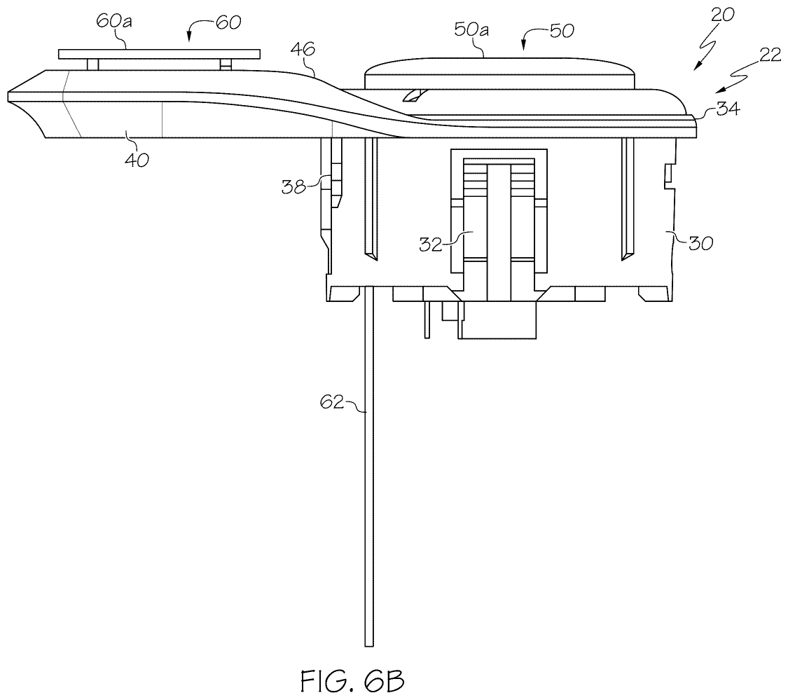

In the embodiments described herein, the second input 60 may be a low-profile input, such as a low-profile button. For example, as depicted most clearly in FIGS. 6A and 6B, a low-profile button may be utilized as the second input 60 such that a second input top surface 60a of the second input 60 and a first input top surface 50a of the first input 50 are positioned on a common plane. By positioning the top surfaces 50a, 60a, of the first and second inputs 50, 60 along a common plane, a user may be able to use a thumb or finger to manually translate between the first and second inputs 50, 60 without obstruction. For example, as depicted at least in FIGS. 3-7B, it should be appreciated that the top surfaces 50a, 60a of the first and second inputs 50, 60 may each have a common height relative the housing 22, such that each of the first and second inputs 50, 60 are positioned at an equal distance above (e.g., in the +y-direction as depicted in the coordinate axes of FIGS. 3-7B) the housing 22. Accordingly, the positioning of the first and second inputs 50, 60, as described herein, may aid in ensuring uniformity and enhanced accessibility to a user during operation of the controller 10.

To further aid in minimizing obstruction as a user translates between the first input 50 and the second input 60, the arm 40 of the multi-input adaptor 20 may further include an arcuate portion 46. As depicted in FIGS. 3-7B, the arcuate portion 46 of the arm 40 may extend between the base 30 of the housing 22 and the recess 42 formed within the arm 40. In these embodiments, the arcuate portion 46 of the arm 40 may be configured to adjust a height of the arm 40 relative the base 30 of the housing 22. Accordingly, a curvature of the arcuate portion 46 of the arm 40 may be configured such that the top surfaces 50a, 60a, of the first input 50 and second input 60 are positioned along a common plane when the multi-input adaptor 20 is positioned within the casing 12 of the controller 10.

Furthermore, with reference now to FIGS. 1-7B, it should be appreciated that the base 30 of the housing 22 may extend into at least one of the plurality of input holes 16 formed in the casing 12 of the controller 10, while the arm 40 of the housing 22 is positioned on a surface of the casing 12 of the controller 10. Accordingly, in these embodiments, the arcuate portion 46 of the arm 40 may further increase the positional versatility of the multi-input adaptor 20 when the multi-input adaptor 20 is secured to the controller 10. For example, in some embodiments, the curvature of the arcuate portion 46 of the arm 40 may be such that the arm 40 may be positioned to extend at least partially over a rim of an adjacent input of the plurality of inputs 14. In these embodiments, the overlap of the arm 40 and the rim of the adjacent input may decrease the proximity between the second input 60 and the adjacent input on the controller 10, thereby enhancing the ability of a user to customize the overall layout of the plurality of inputs 14 on the controller 10.

Referring still to FIGS. 1-7B, it should be further appreciated that a length of the arm 40 may be configured to accommodate various ergonomic preferences. For example, a user with relatively smaller hands may prefer that the first input 50 be positioned in closer proximity to the second input 60, while a user with larger hands may prefer that the proximity between the first input 50 and the second input 60 may be greater. In the embodiments described herein, it should be further appreciated that the proximity (e.g., closeness) of the first and second inputs 50, 60 may further allow for users (of any hand size) to adjust the proximity of the first and/or second input 50, 60 relative the additional plurality of inputs 14 disposed on the controller 10 In particular, the proximity of the inputs (e.g., the first and second inputs 50, 60 and the plurality of inputs 14) may alter the ergonomic range of motion required to access the plurality of inputs 10 disposed on the controller 10, such that a user may access each of the inputs with minimal effort and hand strain. In these embodiments, a user may also utilize multiple inputs simultaneously with one finger or thumb due to the closeness in proximity of the first input 50 and the second input 60. Accordingly, it should be understood that arm 40 may be configured to have any length without departing from the scope of the present disclosure, as may be desired by a particular user.

Furthermore, although the first input 50 is depicted as being a circular-shaped button and the second input 60 is depicted as being a square-shaped button, it should be appreciated that the first input 50 and the second input 60 may be any sized and/or shaped input without departing from the scope of the present disclosure. In these embodiments, it should also be understood that the first input 50 and the second input 60 may be the same or different inputs. For example, in some embodiments, the first input 50 and the second input 60 may each include a square button, a circular button, or any other similar input, while in other embodiments (e.g., such as those depicted in FIGS. 1-7B), the first input 50 and the second input 60 may be inputs having distinct types (e.g., shape, size, and/or function).

Although not depicted, in embodiments, it should be appreciated that the housing 22 may include a plurality of arms 40. Accordingly, in these embodiments, the multi-input adaptor may include any number of inputs equivalent to the number of the plurality of arms 40 extending from the housing 22. As such, the multi-input adaptor 20 may include three, four, five, or any other number of inputs having wiring extending through a shared input hole of the plurality of input holes 16 without departing from the scope of the present disclosure.

Referring still to FIGS. 1-7B, it should be understood that the housing 22 is formed as a single, monolithic structure, such that the arm 40 is integrally formed with and extends from the base 30 of the housing 22 of the multi-input adaptor 20. Accordingly, the arm 40 of the housing 22 may be fixed (e.g., in terms of proximity and angular orientation) relative the base 30 of the housing 22. In these embodiments, when the base 30 of the housing 22 is inserted into one of the plurality of input holes 16 formed in the controller 10, the arm 40 may be positioned on the surface of the controller 10 in a particular location as desired by a user. The monolithic structure of the housing 22 may then ensure that the second input 60 does not translate relative the first input 50 during user gameplay.

Although not depicted, it should be further appreciated that, in some embodiments, the arm 40 may be a separate structure coupled to the base 30 of the housing 22. In these embodiments, the arm 40 may be rotatable about the base 30 of the housing 22, such that a user may adjust the positioning of the arm 40 on the surface of the controller 10 after the base 30 of the housing 22 is secured within one of the plurality of input holes 16. In this embodiments, the arm 40 and/or the base 30 of the housing 22 may further include a locking mechanism configured to secure the arm 40 at a desired orientation relative the base 30 of the housing 22.

Furthermore, in other embodiments, the arm 40 may be extendable relative the base 30 of the housing 22, such that a user may adjust the proximity between the first input 50 and the second input 60. In these embodiments, the arm 40 may include a first arm member and a second arm member, with the second arm member including the recess 42 for housing the second input 60 and being translatable relative the first arm member. As should be appreciated, translation of the second arm member relative the first arm member (e.g., in a longitudinal direction) may allow a user to adjust the proximity between the second input 60 and the first input 50 secured within the base 30 of the housing. In these embodiments, the first and/or second arm member may further include a locking mechanism configured to secure the first and/or second arm member in position when a user has achieved a desired proximity between the first input and the second input.

Turning now to FIG. 8, an illustrative flow diagram of a method 800 of modifying a controller with a multi-input adaptor is disclosed. As depicted at block 810, the method may involve removing an input from an input hole formed in a casing of a controller.

With the input removed from the input hole, the method may advance to block 820, which may involve extending a first wiring system of a first input of the multi-input adaptor and a second wire of a second input of the multi-input adaptor through a base of a housing of the multi-input adaptor. In these embodiments, the housing may include a base configured to house the first input, and an arm configured to house the second input, with the arm extending radially outward from the base of the housing. Furthermore, in the embodiments described herein, the method of extending the second wire of the second input through a base of the housing may further involve extending the second wire through an arm aperture formed in a recess of the arm and through a base aperture formed in the base of the housing.

Once the first wiring system and the second wiring system of the first input and second input have been inserted through the base, respectively, the method may advance to block 830, which may involve inserting the multi-input adaptor into the input hole, such that the base of the housing of the multi-input adaptor extends into the input hole and the arm of the multi-input adaptor is positioned on a surface of the casing of the controller. With the multi-input adaptor positioned on the controller, the method may advance to block 840, which may involve electrically coupling, via a common input hole, the first wiring system of the first input and the second wiring system of the second input to a circuit board of the controller.

In view of the foregoing, it should be appreciated that embodiments described herein relate to a multi-input adaptor for a controller, controllers, and methods of modifying a controller with a multi-input adaptor. The multi-input adaptor for a controller includes a housing having a base defining a base hole and an arm extending radially outward from the base, the arm defining a recess. The multi-input adaptor further includes a first input positioned within the base hole and a second input positioned within the recess of the arm. A first wiring system of the first input and a second wiring system of the second input each extend through the base hole of the base. In the embodiments described herein, the multi-input adaptor may replace traditional controller inputs, thereby allowing a user to customize and/or modify the controller to increase the quantity of inputs available on the controller.

The embodiments disclosed herein may be further described with reference to the following aspects:

According to one aspect of the disclosure, and potentially in combination with other disclosed aspects of the disclosure, a multi-input adaptor for a controller comprises: a housing comprising: a base defining a base hole; and an arm extending radially outward from the base, the arm defining a recess; a first input positioned within the base hole; and a second input positioned within the recess of the arm; wherein a first wiring system of the first input and a second wiring system of the second input each extend through the base hole of the base.

According to one aspect of the disclosure, and potentially in combination with other disclosed aspects of the disclosure, the base further comprises a plurality of projections extending radially outward from the base.

According to one aspect of the disclosure, and potentially in combination with other disclosed aspects of the disclosure, the plurality of projections are elastically deformable.

According to one aspect of the disclosure, and potentially in combination with other disclosed aspects of the disclosure, the base may further comprise a rim extending around an outer perimeter of the base, and the first input is positioned within the base such that the first input abuts the rim of the base.

According to one aspect of the disclosure, and potentially in combination with other disclosed aspects of the disclosure, the recess of the arm further includes an arm aperture extending at least partially through the arm.

According to one aspect of the disclosure, and potentially in combination with other disclosed aspects of the disclosure, the base further comprises a base aperture positioned adjacent the arm aperture.

According to one aspect of the disclosure, and potentially in combination with other disclosed aspects of the disclosure, the second wiring system of the second input extends through the arm aperture and the base aperture and into the base hole.

According to one aspect of the disclosure, and potentially in combination with other disclosed aspects of the disclosure, the second input may be a low-profile button.

According to one aspect of the disclosure, and potentially in combination with other disclosed aspects of the disclosure, a first input top surface of the first input and a second input top surface of the second input are positioned on a common plane.

According to one aspect of the disclosure, and potentially in combination with other disclosed aspects of the disclosure, the arm further comprises an arcuate portion extending between the recess and the base.

According to one aspect of the disclosure, and potentially in combination with other disclosed aspects of the disclosure, a controller includes: a casing; a plurality of input holes formed in the casing; a plurality of inputs positioned within the plurality of input holes; and at least one multi-input adaptor positioned in at least one of the plurality of input holes, the at least one multi-input adaptor comprising: a housing comprising: a base extending into the at least one of the plurality of input holes, the base defining a base hole; and an arm extending radially outward from the base and being positioned on a surface of the casing of the controller, the arm defining a recess; a first input positioned within the base hole; and a second input positioned within the recess of the arm; wherein a first wiring system of the first input and a second wiring system of the second input each extend through the base hole of the base and the at least one of the plurality of input holes.

According to one aspect of the disclosure, and potentially in combination with other disclosed aspects of the disclosure, the base of the multi-input adaptor further comprises a plurality of projections extending radially outward from the base, such that the plurality of projections abut the casing of the controller.

According to one aspect of the disclosure, and potentially in combination with other disclosed aspects of the disclosure, the recess of the arm of the multi-input adaptor further includes an arm aperture extending at least partially through the arm.

According to one aspect of the disclosure, and potentially in combination with other disclosed aspects of the disclosure, the base of the multi-input adaptor further comprises a base aperture positioned adjacent the arm aperture.

According to one aspect of the disclosure, and potentially in combination with other disclosed aspects of the disclosure, the second wiring system of the second input extends through the arm aperture and the base aperture and into the base hole positioned within the at least one of the plurality of input holes.

According to one aspect of the disclosure, and potentially in combination with other disclosed aspects of the disclosure, the second input of the multi-input adaptor is a low-profile button.

According to one aspect of the disclosure, and potentially in combination with other disclosed aspects of the disclosure, a first input top surface of the first input and a second input top surface of the second input are positioned on a common plane.

According to one aspect of the disclosure, and potentially in combination with other disclosed aspects of the disclosure, the arm of the multi-input adaptor further comprises an arcuate portion extending between the recess and the base.

According to one aspect of the disclosure, and potentially in combination with other disclosed aspects of the disclosure, the arcuate portion of the arm of the multi-input adaptor has a curvature such that the arm of the multi-input adaptor extends at least partially over an adjacent input of the plurality of inputs of the controller.

According to one aspect of the disclosure, and potentially in combination with other disclosed aspects of the disclosure, a method of modifying a controller with a multi-input adaptor includes: removing an input from an input hole formed in a casing of the controller; extending a first wiring system of a first input of the multi-input adaptor and a second wire of a second input of the multi-input adaptor through a base of a housing of the multi-input adaptor; inserting the multi-input adaptor into the input hole, such that the base of the housing of the multi-input adaptor extends into the input hole and an arm of the multi-input adaptor is positioned on a surface of the casing of the controller; and electrically coupling, via the input hole, the first wiring system of the first input and the second wiring system of the second input to a circuit board of the controller.

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A multi-input adaptor for a controller comprising:
a housing comprising:
a base defining a base hole; and
an arm extending radially outward from the base, the arm defining a recess;
a first input positioned within the base hole; and
a second input positioned within the recess of the arm;
wherein a first wiring system of the first input and a second wiring system of the second input each extend through the base hole of the base.

2. The multi-input adaptor of claim 1, wherein the base further comprises a plurality of projections extending radially outward from the base.

3. The multi-input adaptor of claim 2, wherein the plurality of projections are elastically deformable.

4. The multi-input adaptor of claim 1, wherein the base further comprises a rim extending around an outer perimeter of the base, and the first input is positioned within the base such that the first input abuts the rim of the base.

5. The multi-input adaptor of claim 1, wherein the recess of the arm further includes an arm aperture extending at least partially through the arm.

6. The multi-input adaptor of claim 5, wherein the base further comprises a base aperture positioned adjacent the arm aperture.

7. The multi-input adaptor of claim 6, wherein the second wiring system of the second input extends through the arm aperture and the base aperture and into the base hole.

8. The multi-input adaptor of claim 1, wherein the second input is a low-profile button.

9. The multi-input adaptor of claim 1, wherein a first input top surface of the first input and a second input top surface of the second input are positioned on a common plane.

10. The multi-input adaptor of claim 1, wherein the arm further comprises an arcuate portion extending between the recess and the base.

11. A controller comprising:
a casing;
a plurality of input holes formed in the casing;
a plurality of inputs positioned within the plurality of input holes; and
at least one multi-input adaptor positioned in at least one of the plurality of input holes, the at least one multi-input adaptor comprising:
a housing comprising:
a base extending into the at least one of the plurality of input holes, the base defining a base hole; and
an arm extending radially outward from the base and being positioned on a surface of the casing of the controller, the arm defining a recess;
a first input positioned within the base hole; and
a second input positioned within the recess of the arm;
wherein a first wiring system of the first input and a second wiring system of the second input each extend through the base hole of the base and the at least one of the plurality of input holes.

12. The controller of claim 11, wherein the base of the multi-input adaptor further comprises a plurality of projections extending radially outward from the base, such that the plurality of projections abut the casing of the controller.

13. The controller of claim 11, wherein the recess of the arm of the multi-input adaptor further includes an arm aperture extending at least partially through the arm.

14. The controller of claim 13, wherein the base of the multi-input adaptor further comprises a base aperture positioned adjacent the arm aperture.

15. The controller of claim 14, wherein the second wiring system of the second input extends through the arm aperture and the base aperture and into the base hole positioned within the at least one of the plurality of input holes.

16. The controller of claim 11, wherein the second input of the multi-input adaptor is a low-profile button.

17. The controller of claim 11, wherein a first input top surface of the first input and a second input top surface of the second input are positioned on a common plane.

18. The controller of claim 11, wherein the arm of the multi-input adaptor further comprises an arcuate portion extending between the recess and the base.

19. The controller of claim 18, wherein the arcuate portion of the arm of the multi-input adaptor has a curvature such that the arm of the multi-input adaptor extends at least partially over an adjacent input of the plurality of inputs of the controller.

20. A method of modifying a controller with a multi-input adaptor, the method comprising:
removing an input from an input hole formed in a casing of the controller;
extending a first wiring system of a first input of the multi-input adaptor and a second wire of a second input of the multi-input adaptor through a base of a housing of the multi-input adaptor;
inserting the multi-input adaptor into the input hole, such that the base of the housing of the multi-input adaptor extends into the input hole and an arm of the multi-input adaptor is positioned on a surface of the casing of the controller; and
electrically coupling, via the input hole, the first wiring system of the first input and the second wiring system of the second input to a circuit board of the controller.
